(19) United States
(12) Patent Application Publication
(10) Pub. No.: US 2024/0083037 A1
(43) Pub. Date: Mar. 14, 2024

(54) System and Method for Robotic Food and Beverage Preparation Using Computer Vision

(71) Applicant: Blue Hill Tech, Inc., Seattle, WA (US)

(72) Inventors: SHUO LIU, (US); MENG WANG, (US); XUCHU DING, (US); YUSHAN CHEN, (US); QIHANG WU, (US)

(21) Appl. No.: 18/273,826

(22) PCT Filed: May 20, 2021
(86) PCT No.: PCT/US21/33430

§ 371 Date: Jul. 24, 2023

Related U.S. Application Data
(60) Provisional application No. 63/028,109, filed on May 21, 2020.

(51) Int. Cl. B25J 9/16; A47J 31/52; B25J 9/00; B25J 11/00; G06T 7/20; G06T 7/70

(52) U.S. Cl. CPC B25J 9/1697; A47J 31/52; B25J 9/0081; B25J 11/008; G06T 7/20; G06T 7/70; G06T 2207/10016; G06T 2207/20081; G06T 2207/30241

(57) ABSTRACT

A method including providing a visual cue associated with and in close physical proximity to an object, detecting a pose of the visual cue with a camera coupled to the robot arm, training by guiding the robot arm from a first position to a target position near the object based on external input, recording, by the camera, trajectory data based on the pose of the visual cue during movement of the robot arm from the first position to the target position and storing the trajectory data in memory, receiving an instruction to move the robot arm to the object, providing a sequence of robot arm trajectory instructions relative to the pose of the visual cue based on input from the camera and trajectory data to guide the robot arm to the target position.

### CROSS-REFERENCE TO RELATED APPLICATIONS

The present application is a United States National Stage (§ 371) application of PCT/US21/33430 filed May 20, 2021, which claims the benefit of U.S. Provisional Patent Application Ser. No. 63/028,109, filed on May 21, 2020, the contents of which are hereby incorporated by reference in their entirety.

### BACKGROUND

### Technical Field

The present disclosure pertains to robotic systems and methods that utilize artificial intelligence and, more particularly, to beverage and food preparation in an open environment using computer vision to locate and manipulate utensils, cookware, and ingredients that do not have a fixed location, and prepare and serve the beverage and food to the consumer with little to no human interaction. The present disclosure further relates to the field of using a visual guided system for a robot to perform food and beverage preparation and service tasks in a manner that is very similar to those of experienced human baristas.

### Description of the Related Art

Current methods for making specialty coffee drinks involve one or more human baristas to operate a commercial coffee machine. Typical steps of operation include grinding the coffee and collecting the ground coffee in a portable filter basket (known as a portafilter), tamping the coffee in the portafilter, inserting and locking the portafilter in the coffee machine, preparing the coffee by running hot water through the portafilter basket to extract a liquid “shot” of coffee, and finally, pouring the liquid coffee in a cup where it may be mixed with other ingredients. For a milk drink, additional steps include steaming and frothing the milk in a pitcher, and pouring the steamed milk into a cup. Optional latte art may be added to the very top surface of the drink. All of the foregoing steps or tasks are repetitive movements that require basic but consistent motor functions.

Attempts have been made to utilize robotics for performing the foregoing tasks. However, such attempts generally require the system to be in a closed box, and as such items and tools in the environment are fixed in location. This allows one to program robots to perform predefined and hardcoded motions that can complete these tasks given that the placement of the items do not change. However, in realistic working conditions in coffee shops, utensils and cookware are constantly moved about by baristas, and even with a robotic assistant, there is the issue of the robotic assistant being able to locate the correct utensil for the desired task.

Some other attempts have been made to utilize computer vision for performing some of tasks previously performed by humans. However, these attempts focus on recognizing and locating certain objects, instead of on how to modify robot motions to account for a constantly changing environment.

Attempts have been made to utilize computer vision for monitoring the environment and identifying conditions to act on. However, these attempts focus on raising alarms for critical conditions, instead of how to modify robot motions to resolve such situations.

Other attempts have been made to utilize computer vision for human recognition and understanding. However, these attempts focus on learning human behavior, instead of driving robots to interact with humans.

### BRIEF SUMMARY

The present disclosure is directed to a modular robotic coffee barista station that is configured to prepare espresso drinks, cold brew, iced coffee, and drip coffee using commercial coffee equipment. The present disclosure also focuses on using computer vision to aid a robot in food and beverage making tasks so that these tasks may be completed even when the operational environment has and may continue to change. The present disclosure also allows a coffee-making solution where a human barista works alongside robots collaboratively.

In accordance with another aspect of the present disclosure, a robotic coffee preparation and serving station is provided that includes a six-axis robot arm controlled by executable software on a processor, gripper that can be controlled by the processor and a camera that is capable of taking high resolution images.

In accordance with another aspect of the present disclosure, a method of guiding a robot relative to an object that does not have a fixed location is provided. The method includes providing a camera, providing a visual cue associated with the object, detecting a pose of the visual cue with the camera, and providing to a controller a sequence of robot trajectory instructions relative to the pose of the visual cue to guide the robot to the object.

In accordance with another aspect of the foregoing disclosure, the method includes an initial step of pre-recording and saving in an electronic memory associated with the controller the sequence of robotic trajectory instructions.

In accordance with a further aspect of the foregoing disclosure, the method includes repeating the detecting and providing to the controller the sequence of robotic trajectory instructions until the desired food or beverage has been prepared and served.

In accordance with a further aspect of the foregoing disclosure, the method includes monitoring physical change in the environment and controlling the movement of the robot without colliding with the environment. The method includes providing a camera, providing a visual cue associated with the environment, detecting physical changes in the visual cue with the camera, and planning collision free robot trajectory accounting for the changes in the environment.

In accordance with a further aspect of the foregoing disclosure, the method includes monitoring various environmental conditions and guiding the robot to adjust to such environmental change. The method includes providing a camera, providing a visual cue associated with the object, detecting conditions of the visual cue with the camera, and adjusting the sequence of robot trajectory instructions to guide the robot handling the change in condition.

In accordance with a further aspect of the foregoing disclosure, the method includes identifying human beings and interacting with them. The method includes providing a camera, providing a visual cue associated with customers waiting to pick up their order, identifying who the order is for and guide the robot to deliver the order to the target customer.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is a flow chart illustrating the steps to record a visually guided trajectory in accordance with one aspect of the present disclosure.

FIG. 2 illustrates a robotic arm system formed in accordance with one aspect of the present disclosure.

FIG. 3 illustrates a robotic arm system formed in accordance with one aspect of the present disclosure.

FIG. 4 illustrates a robotic arm system formed in accordance with one aspect of the present disclosure.

FIG. 5 is a flow chart of the steps of the second visual guided system in accordance with one aspect of the present disclosure.

FIG. 6 is a flow chart of the steps of a third visual guided system in accordance with one aspect of the present disclosure.

FIG. 7 is a flow chart of the steps of a fourth visual guided system in accordance with one aspect of the present disclosure.

### DETAILED DESCRIPTION

The present disclosure describes a system that allows one to capture complex motions to be executed by a robot, which are guided and modified by visual or other sensory input. Methods for such visual-guided systems are described below.

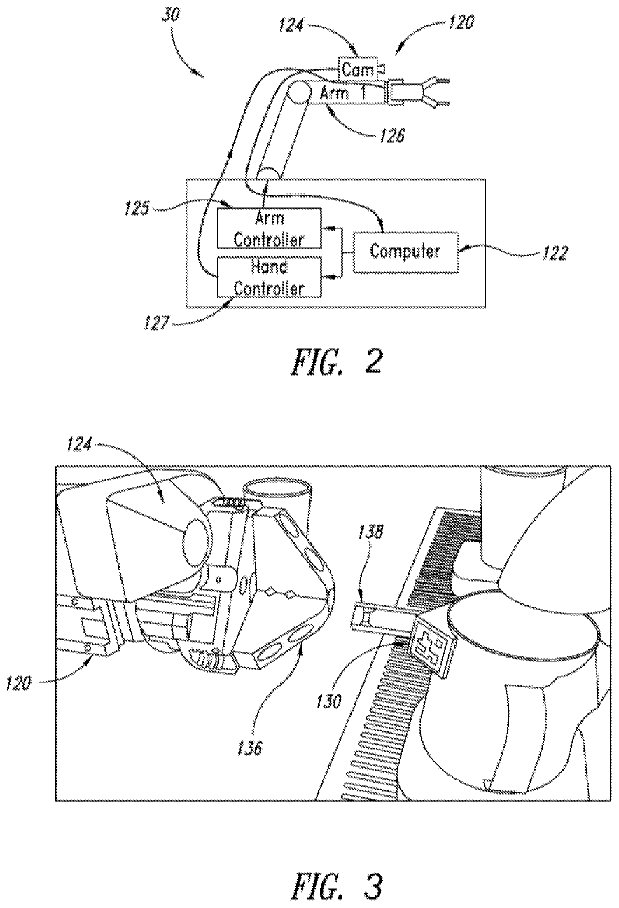

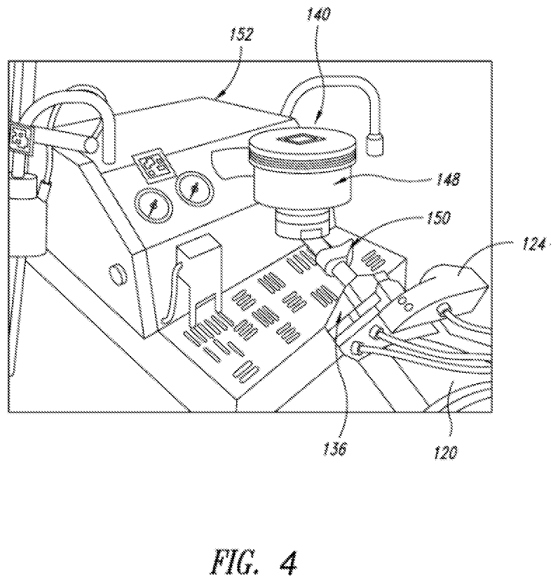

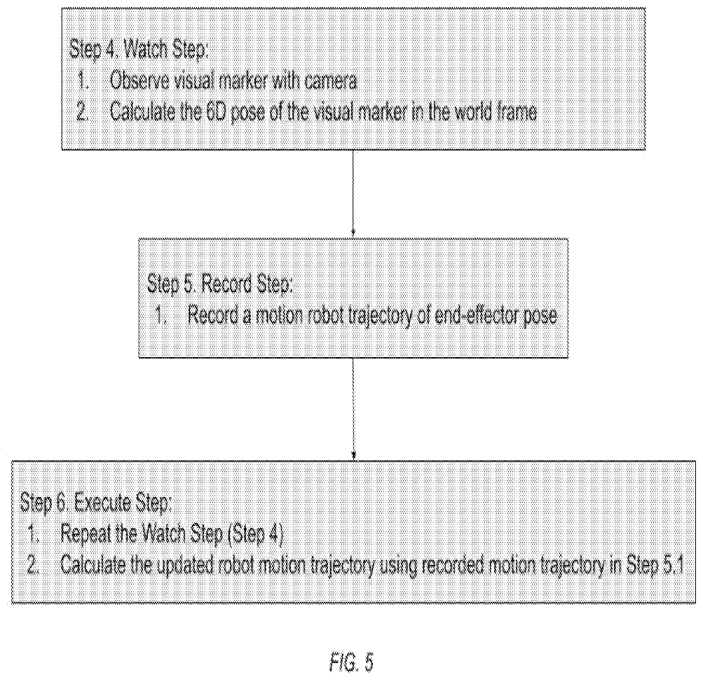

FIG. 2 shows a robotic arm system 30 according to an aspect of the present disclosure. The computer 122, which may include one or more processors and memory, receives input from the camera 124 and generates a control signal from the arm controller 125 for the arm 126 and from the hand controller 127 for the end effector 120. End effector 120 may be located at a distal point on the arm 126 and may be used to detect, identify, and locate the object in an environment and to determine its position or orientation (referred to herein as POSE). This allows the arm 126 to encounter objects, such as a milk jar, in the environment, even though the object is not placed in the same location each time. Camera 124 may be used in conjunction with computer vision software to allow the robotic arm system 30 to identify where an object, e.g., group head 148 (shown in FIG. 4) of an espresso machine 152, is located and positioned relative to the end effector 120. Even when an object, for example, a part of the espresso machine, has moved by a few inches, the robotic arm system 30 will be capable of detecting and locating the object.

By using the camera 124, the robotic arm system 30 can place an object, such as a coffee cup, on a counter or other work surface without hitting existing objects, such as other cups, on the counter. After a food item or beverage is prepared, the robotic arm system 30 may place it on the counter or on another designated surface where the customer can pick it up. The robotic arm system 30 may use the on-board camera 124 to find an empty space to place the item so that it does not hit any objects on the counter. The computer vision system will also identify human hands and ensure moving parts, such as arm 126, avoids the human hands.

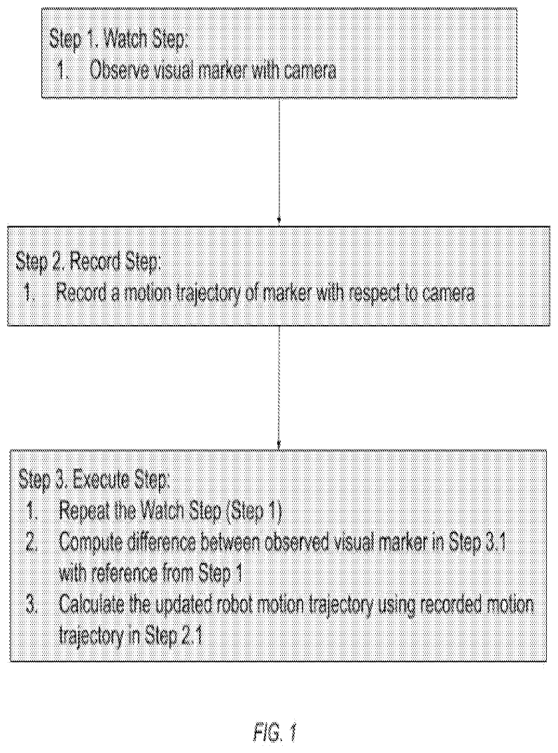

FIG. 1 illustrates a method for recording and executing a robot trajectory relative to a visual object. In the “Watch Step” (Step 1) a visual marker 130 may be observed by the computer vision device, such as a camera 124 coupled to and moving with the robotic arm 126 (shown in FIG. 2), and an observation signal may be sent to a processor, such as computer 122 (shown in FIG. 2), where the position and orientation of the visual marker may then be computed. During learning, the position and orientation of the visual marker 130 may be recorded by the camera 124 and stored in memory, in one aspect, continuously, with respect to a desired motion. Position and orientation of the camera 124 and/or arm 126 may be controlled by the user, for example, by using a teaching pendant; moving by hand to waypoints; and/or computing and moving to points relative to the current location. In the “Record Step” (Step 2), the processor may then compute and save in memory a trajectory of robot motion relative to the observed visual marker 130. The motion trajectory may be represented by continuously observed visual marker position and orientation. During execution in “Execution Step” (Step 3), the position and orientation of the visual marker may be continuously observed and updated by the camera 124 (Step 3.1). The robotic arm 126 may follow a trajectory so that its end-effector 120 executes a desired motion relative to position and orientation of the visual marker (Step 3.2 and Step 3.3).

FIG. 3 illustrates a robotic arm system 30 formed in accordance with one aspect of the present disclosure. During Execution Step (Step 3), camera 124 may capture locations of the visual marker 130 (mounted next to the cup handle 138), and the arm 126 position and orientation may be continuously updated relative to the position and orientation of the visual marker 130 until it finishes executing the desired trajectory, e.g., when the gripper 136 is open and fully inserted into the cup handle 138. The gripper 136 may then close and complete the desired motion. Such continuous updating of the position and orientation of the arm 126 may be preferred when interacting with objects that are not fixed or can easily be moved or reoriented, such as a cup.

FIG. 5 describes another method of recording and executing a robot trajectory relative to a visual object. During “Watch Step” (Step 4), the position and orientation of the visual marker 130 may be observed by the camera 124, and the 6D marker position and orientation in the world frame may be calculated through camera intrinsic/extrinsic and robot forward kinematics (Step 4.2). In the “Record Step” (Step 5), the desired motion of the robot may be recorded in the form of the 6 dimension position and orientation of the end-effector 120. The direct recording may be joint angles of the robot, and the end-effector pose may be computed through forward kinematics. The recorded motion trajectory may be transformed and stored to relative pose with respect to the end-effector pose when capturing this fixed visual marker pose (Step 5.1). During execution, as in “Execution Step” (Step 6), the position and orientation of the visual marker may be observed first by the camera sensor (Step 6.1), and the robot may follow a trajectory so that its end-effector 120 executes a desired motion relative to position and orientation of the observed visual marker (Step 6.2).

An example of the method shown in FIG. 5 can be described with reference to FIG. 4. Camera 124 may capture locations of the visual marker 140 mounted next to the coffee machine group head 148. The group head 148 is a permanent attachment to the coffee machine that brings water out of the machine and into the filter basket. As such, the group head 148 is not expected to move unless the entire coffee machine moves, which may be unlikely to occur due to the weight and installation of the coffee machine. The robot position and orientation relative to visual marker 140 is recorded as the motion of going up the group head 148, and turning in until the portafilter 150 is locked in place. During Execution Step (Step 6), the visual marker 140 is first observed, and the robot motion is updated with respect to the visual marker 140. Because the group head 148 is unlikely to move or change position, the robot motion may be executed without the need to re-observe the visual marker 140 during execution.

A significant difference between the processes shown in FIG. 1 and FIG. 5 is the manner in which the robot arm 126 automatically moves with respect to the visual marker 130. In the method of FIG. 1, the robot arm 126 may continuously move relative toward the visual marker 130, and the system may capture updated data regarding the visual marker 130 position and orientation while the robot arm 126 is moving. In the method of FIG. 5, the visual marker 130 is assumed to be in a fixed location, and the robot arm 126 executes a desired motion with respect to the fixed position and orientation of the visual marker 130. One advantage of the method of FIG. 1 is that it may be well-suited for objects that may change location in the environment, such as milk pitcher 138, coffee cup, and the like, but may require constant or near-constant monitoring of the visual marker 130 and thus may require more computation power than the method of FIG. 5, and further that the visual marker 130 must always be in the field of view of the camera 124. On the other hand, the method of FIG. 5 may be well-suited for objects that are assumed to be stationary while the robot executes the desired motion, and the visual marker 130 may not need to be always in the field of view of the camera 124.

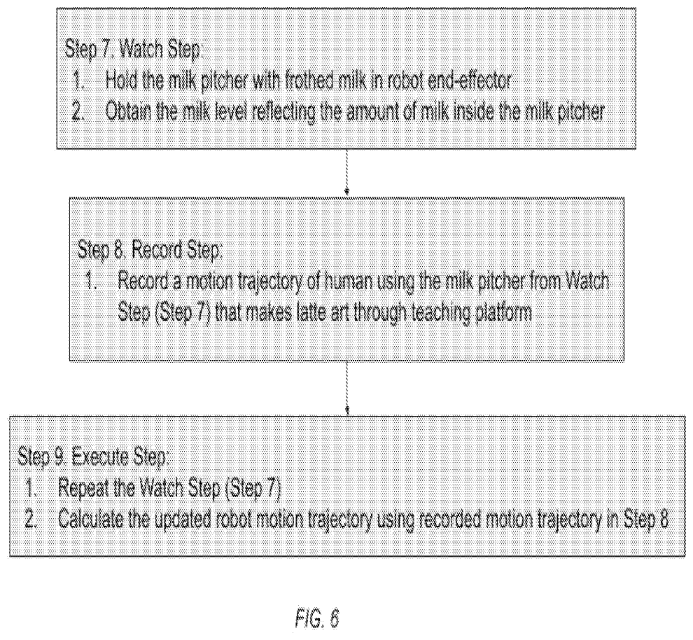

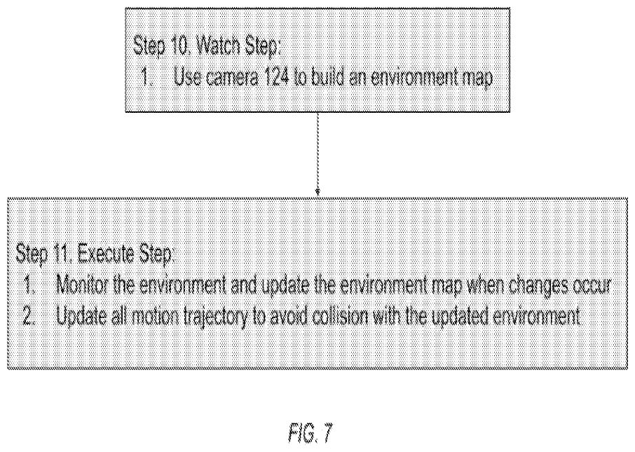

The invention of the present disclosure also provides ways to use computer vision to affect other aspects of coffee making. In FIG. 6, a method is described where the camera may capture imagery of milk in the milk pitcher 138 and update robot motion trajectory to make latte art. During “Watch Step” (Step 7), the amount of milk in the milk pitcher 138 when the robotic arm 126 is holding the milk pitcher 138 may be determined with camera 124 and computer vision (Step 7.1 and 7.2). In “Record Step” (Step 8), the motion trajectory of a human making latte art may be recorded through human demonstration using motion capture techniques (Step 8.2) and replicated by the robot, and the observed milk level (Step 8.1) may be recorded as reference. During “Execution Step” (Step 9), they system may again calculate the milk level (Step 9.1), and if the steamed milk is more than a predetermined nominal amount, the motion trajectory for operating the milk pitcher 138 will be adjusted by a certain predefined rule (tilted back, for example), to help ensure that liquid does not overflow in the cup (Step 9.2).

The invention of the present disclosure may use computer vision to handle dynamic changes in the environment. In FIG. 7, a method is shown where the camera may be used to capture imagery of the environment and identifies a customer who placed her bag on the table along the path which the robot previously took to place the cup on the counter. During learning in “Watch Step” (Step 10), the static environment may be constructed with a visual camera 124. During execution in “Execution Step” (Step 11), environment change may be continuously monitored (Step 11.1), and when a new object enters and blocks the desired robot execution path, the system may recalculate a new collision free path to avoid the bag and place the cup on the counter (Step 11.2).

The present disclosure allows ways to use computer vision to identify customers waiting for their order, localizing them and controlling the robot to deliver the order to the target customer.

As desired, embodiments of the disclosure may include systems with more or fewer components than are illustrated in the drawings. Additionally, certain components of the systems may be combined in various embodiments of the disclosure. The systems described above are provided by way of example only.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

1. A method for guiding a robot arm, comprising:
providing a visual cue associated with and in close physical proximity to an object;
detecting a position and orientation of the visual cue with a camera mechanically coupled to the robot arm;
training by guiding the robot arm from a first position to a target position near the object based on external input;
recording, by the camera, trajectory data based on the position and orientation of the visual cue during movement of the robot arm from the first position to the target position and storing the trajectory data in memory;
receiving an instruction to move the robot arm to the object;
providing, in response to the instruction to move the robot arm, to a controller a sequence of robot arm trajectory instructions relative to the position and orientation of the visual cue based on input from the camera and trajectory data to automatically guide the robot arm to the target position.

2. The method of claim 1, wherein the external input comprises one of physical manipulation of the robot arm by a human, human manipulation of a teaching pendant, and computing and moving to points relative to a current location of the robot arm.

3. The method of claim 1, wherein the sequence of robot arm trajectory instructions are calculated based on a difference between a current visual cue and the current position of the robot arm and the recorded visual que and the recorded position of the robot arm.

4. The method of claim 1, wherein the camera provides a substantially continuous stream of video input during one or more of the recording and providing steps.

5. The method of claim 1, wherein the robot arm comprises an end effector capable of interacting with the object when the robot arm is in the target position.

6. The method of claim 5, wherein the end effector is a gripper, and the object is one of a movable object and a movable portion of a coffee making apparatus.

7. A method for guiding a robot arm, comprising:
providing a visual cue associated with and in close physical proximity to an object;
detecting a pose of the visual cue with a camera mechanically coupled to the robot arm;
calculating a 6D marker pose of the visual cue based on camera input and robot forward kinematics;
training, by guiding the robot arm from a first position to a target position near the object based on external input;
recording, by the camera, trajectory data based on a joint state of the robot arm during movement of the robot arm from the first position to the target position and storing the trajectory data in memory;
receiving an instruction to move the robot arm to the object;
providing, in response to the instruction to move the robot arm, to a controller a sequence of robot arm trajectory instructions based on recorded trajectory data to automatically cause the robot arm to follow a trajectory to the target position.

8. The method of claim 7, wherein the external input comprises one of physical manipulation of the robot arm by a human, human manipulation of a teaching pendant, and computing and moving to points relative to a current location of the robot arm.

9. The method of claim 7, wherein the robot arm comprises an end effector capable of interacting with the object when the robot arm is in the target position.

10. The method of claim 9, wherein the end effector is a gripper, and the object is a portion of a coffee making apparatus.

11. The method of claim 9, wherein end-effector pose may be computed through forward kinematics.
